(19) United States
(12) Patent Application Publication
(10) Pub. No.: US 2026/0177684 A1
(43) Pub. Date: Jun. 25, 2026

(54) PROGRAM, INFORMATION PROCESSING DEVICE, AND INFORMATION PROCESSING METHOD

(71) Applicant: Sony Group Corporation, Tokyo (JP)

(72) Inventors: Tetsuro SATO, Tokyo (JP); Hiroyuki KAMATA, Kanagawa (JP); Kenei MATSUDAIRA, Tokyo (JP)

(73) Assignee: Sony Group Corporation, Tokyo (JP)

(21) Appl. No.: 19/127,412

(22) PCT Filed: Dec. 12, 2023
(86) PCT No.: PCT/JP2023/044360

§ 371 Date: May 6, 2025

(30) Foreign Application Priority Data
Dec. 26, 2022 (JP) 2022-208193

(51) Int. Cl. G01S 13/76; G01S 13/02; G01S 19/07; G01S 19/11; G01S 19/14

(52) U.S. Cl. CPC G01S 13/76; G01S 13/0209; G01S 19/071; G01S 19/11; G01S 19/14

(57) ABSTRACT

There is provided a program, an information processing device, and an information processing method that, even in a case where there is a plurality of transmission devices and each of the plurality of transmission devices asynchronously transmits a modulated signal, enable a reception device to appropriately measure a position on the basis of this asynchronously transmitted modulated signal. A distance between each transmission device and an electronic device is found from a propagation time that is a time until an audio signal constituted by a spreading code signal output from an audio transmission block is propagated to the electronic device. When the electronic device moves at a predetermined velocity, the position of the electronic device is calculated on the basis of distance differences between the transmission device and the electronic device per unit time arising along with the movement. The present disclosure can be applied to a game controller or an HMD.

### TECHNICAL FIELD

The present disclosure relates to a program, an information processing device, and an information processing method and, more particularly, to a program, an information processing device, and an information processing method that, even when each of a plurality of devices at a transmitting side asynchronously has a modulated signal, enable a device at a receiving side to appropriately measure a position on the basis of this asynchronously transmitted modulated signal.

### BACKGROUND ART

There is a technology in which a transmission device modulates a data code with a code sequence to generate a modulated signal and emits the modulated signal as sound, while a reception device receives the emitted sound, correlates the modulated signal that is the received audio signal with the code sequence, and measures a distance to the transmission device on the basis of a peak of correlation.

By using this position measurement technology, the reception device can measure its self position on the basis of the distance to each of a plurality of transmission devices as long as the positions of the plurality of transmission devices are known.

However, in this case, when measuring the self position, since it is premised that the plurality of transmission devices synchronously transmits modulated signals, the reception device is not allowed to appropriately measure the self position if the plurality of transmission devices does not synchronously transmit the modulated signals.

As a technology for handling signals transmitted asynchronously by a plurality of devices, a technology has been proposed in which, in a case where a plurality of reception devices receives signals transmitted from a transmission device that is a moving body in a non-synchronized state, correction is made on the basis of movement information deduced from a motion equation ideal for the transmission device that is a moving body (see Patent Document 1).

### CITATION LIST

### Patent Document

Patent Document 1: Japanese Patent Application Laid-Open No. 2008-203095

### SUMMARY OF THE INVENTION

### Problems to be Solved by the Invention

However, in Patent Document 1, there are a plural number of reception devices, but there are not a plural number of transmission devices, and the reception device is not allowed to make a correction such that signals asynchronously transmitted from a plurality of transmission devices can be treated as signals synchronously transmitted.

The present disclosure has been made in view of such a situation and, in particular, aims to, even in a case where each of a plurality of transmission devices asynchronously transmits a modulated signal, enable a reception device to appropriately measure a position on the basis of this asynchronously transmitted modulated signal.

### Solutions to Problems

An information processing device and a program according to one aspect of the present disclosure are an information processing device and a program including: an audio reception unit that receives an audio signal that is output from an audio output block and is constituted by a spreading code signal obtained by conducting spread spectrum modulation on a spreading code; and a position calculation unit that calculates a position of the audio reception unit or the audio output block on the basis of a distance to the audio output block identified from a propagation time that is a time until the audio signal from the audio output block is propagated to and received by the audio reception unit, in which the position calculation unit calculates the position of the audio reception unit or the audio output block on the basis of a distance difference from the audio output block per unit time when the position calculation unit moves at a predetermined velocity.

An information processing method according to one aspect of the present disclosure is an information processing method including: an audio reception unit that receives an audio signal that is output from an audio output block and is constituted by a spreading code signal obtained by conducting spread spectrum modulation on a spreading code; and a position calculation unit that calculates a position of the audio reception unit or the audio output block on the basis of a distance to the audio output block identified from a propagation time that is a time until the audio signal from the audio output block is propagated to and received by the audio reception unit, the information processing method including a step of calculating, by the position calculation unit, the position of the audio reception unit or the audio output block on the basis of a distance difference from the audio output block per unit time when the position calculation unit moves at a predetermined velocity.

In one aspect of the present disclosure, an audio signal that is output from an audio output block and is constituted by a spreading code signal obtained by conducting spread spectrum modulation on a spreading code is received by an audio reception unit, a position of the audio reception unit or the audio output block is calculated by a position calculation unit on the basis of a distance to the audio output block identified from a propagation time that is a time until the audio signal from the audio output block is propagated to and received by the audio reception unit, and the position of the audio reception unit or the audio output block is calculated by the position calculation unit on the basis of a distance difference from the audio output block per unit time when the position calculation unit moves at a predetermined velocity.

### BRIEF DESCRIPTION OF DRAWINGS

FIG. 1 is a diagram explaining a configuration example of an acoustic positioning system of the present disclosure.

FIG. 2 is a diagram explaining functions implemented by an audio output block in FIG. 1.

FIG. 3 is a diagram explaining functions implemented by an electronic device in FIG. 1.

FIG. 4 is a diagram explaining communication using a spreading code.

FIG. 5 is a diagram explaining autocorrelation and cross-correlation of the spreading code.

FIG. 6 is a diagram explaining a propagation time of the spreading code using cross-correlation.

FIG. 7 is a diagram explaining a configuration example of a propagation time calculation unit.

FIG. 8 is a diagram explaining human hearing.

FIG. 9 is a diagram explaining a frequency shift of the spreading code.

FIG. 10 is a diagram explaining a procedure of frequency shift of the spreading code.

FIG. 11 is a diagram explaining how to find a position of the electronic device of the present disclosure.

FIG. 12 is a flowchart explaining a position measurement process by the electronic device.

FIG. 13 is a flowchart explaining a position measurement process by the audio output block.

FIG. 14 is a flowchart explaining a propagation time calculation process.

FIG. 15 is a diagram explaining an example in which a position gradually detected is gradually corrected even when an initial value is unidentified.

FIG. 16 is a diagram explaining a first modification.

FIG. 17 is a diagram explaining a second modification.

FIG. 18 illustrates a configuration example of a general-purpose computer.

### MODE FOR CARRYING OUT THE INVENTION

Hereinafter, preferred embodiments of the present disclosure will be described in detail with reference to the accompanying drawings.

Note that, in the present description and drawings, constituent elements having substantially the same functional configuration will be given the same reference signs to avoid the description from being redundant.

Modes for carrying out the present technology will be described below. The description will be given in the following order.
1. Preferred Embodiments
2. First Modification
3. Second Modification
4. Example of Execution by Software

### 1. Preferred Embodiments

### <Configuration Example of Acoustic Positioning System>

In particular, the present disclosure makes it possible to measure a position with high accuracy, using a sound without giving discomfort to a user.

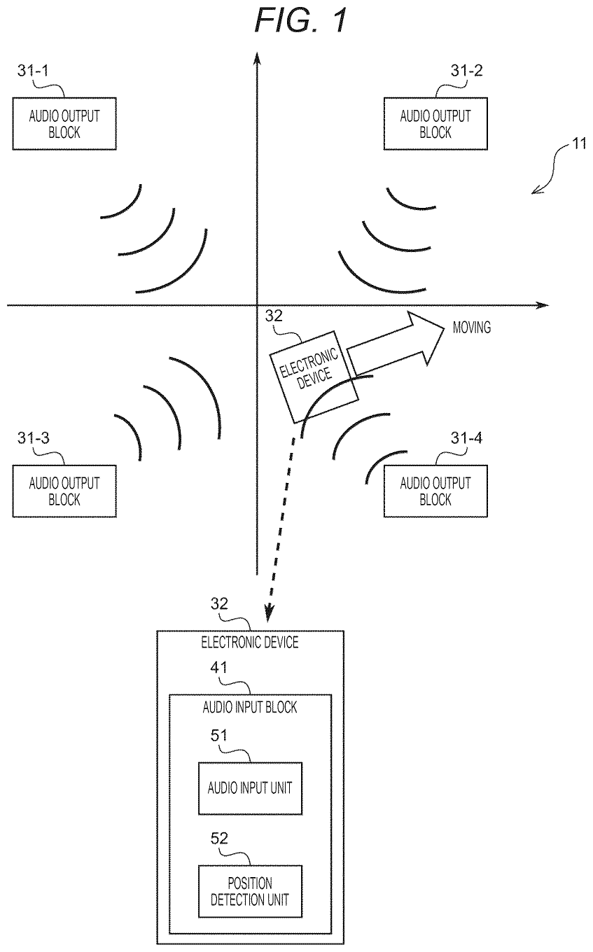

FIG. 1 illustrates a configuration example of an acoustic positioning system to which the technology of the present disclosure is applied.

An acoustic positioning system 11 in FIG. 1 is constituted by audio output blocks 31-1 to 31-4 and an electronic device 32. Note that, in the following, in a case where it is not necessary to particularly distinguish between the audio output blocks 31-1 to 31-4, they will be simply referred to as audio output blocks 31, and other constituents will also be referred to in a similar manner.

Each of the audio output blocks 31-1 to 31-4 includes a speaker and emits sound by including, in sound of music content, a game, or the like or in sound of known music or the like, an audio signal as a ranging signal constituted by a modulated signal obtained by conducting spread spectrum modulation on a data code for identifying a position of the electronic device 32, with a spreading code.

The electronic device 32 is to be carried by or worn by the user and is a smartphone, a head mounted display (HMD), or the like used as a game controller, for example.

The electronic device 32 includes an audio input block 41 including an audio input unit 51 such as a microphone (mic) that receives sound including an audio signal as a ranging signal output from each of the audio output blocks 31-1 to 31-4, and a position detection unit 52.

The audio input block 41 recognizes in advance the position in a space of each of the audio output blocks 31-1 to 31-4 as known position information by communication (using the ranging signal or by other communication means) between the audio output blocks 31 and the electronic device 32. The audio input block 41 causes the audio input unit 51 to receive the audio signal as a ranging signal constituted by the modulated signal included in the sound emitted from the audio output block 31 and outputs the received audio signal to the position detection unit 52. The position detection unit 52 finds a distance to each of the audio output blocks 31-1 to 31-4 on the basis of the audio signal as the ranging signal constituted by the modulated signal supplied from the audio input block 41 and detects its own position relative to the audio output blocks 31-1 to 31-4 on the basis of each of the found distances.

This enables, in a case where the electronic device 32 is, for example, an HMD including a see-through display unit, to track the position of the head of the user wearing the HMD that is the electronic device 32.

In addition, since the position of the HMD as the electronic device 32 relative to the audio output blocks 31-1 to 31-4 is identified, the sound output from the audio output blocks 31-1 to 31-4 can be output after correcting the sound field localization according to the identified position, and thus, the user is allowed to perceive sound with a realistic feeling according to the position of the head of the user.

### <Functional Configuration Example of Audio Output Block>

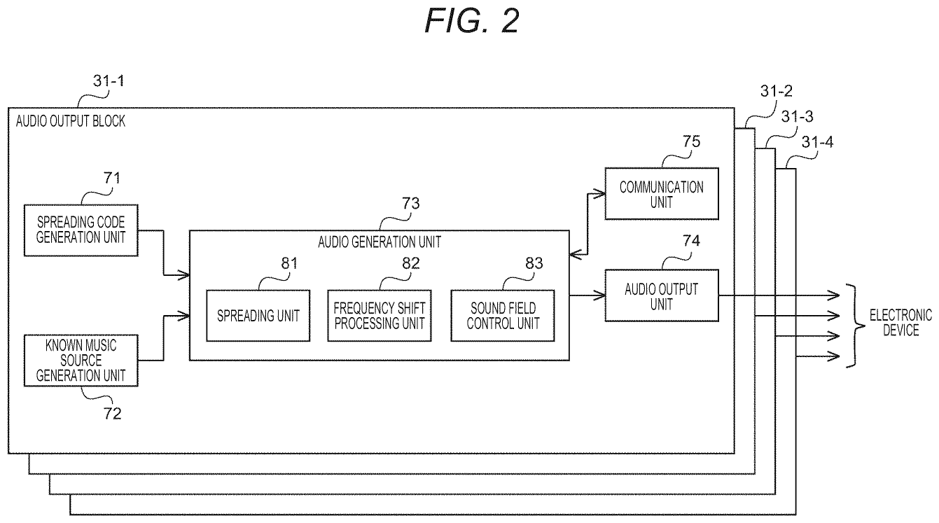

Next, functions implemented by the audio output block 31 will be described with reference to FIG. 2.

The audio output block 31 includes a spreading code generation unit 71, a known music source generation unit 72, an audio generation unit 73, an audio output unit 74, and a communication unit 75.

The spreading code generation unit 71 generates a spreading code and outputs the generated spreading code to the audio generation unit 73.

The known music source generation unit 72 stores known music and generates a known music source on the basis of the stored known music to output the generated known music source to the audio generation unit 73.

The audio generation unit 73 applies spread spectrum modulation with the spreading code to the known music source to generate sound constituted by a spread spectrum signal and outputs the generated sound to the audio output unit 74.

In more detail, the audio generation unit 73 includes a spreading unit 81, a frequency shift processing unit 82, and a sound field control unit 83.

The spreading unit 81 applies spread spectrum modulation with the spreading code to the known music source to generate a spread spectrum signal.

The frequency shift processing unit 82 shifts the frequency of the spreading code in the spread spectrum signal to a frequency band according to the band characteristics of the audio output unit 74.

On the basis of information on the position of the electronic device 32 supplied from the electronic device 32, the sound field control unit 83 reproduces a sound field according to the positional relationship between the electronic device 32 and the sound field control unit 83.

The audio output unit 74 is, for example, a speaker and outputs the known music source supplied from the audio generation unit 73 and sound based on the spread spectrum signal.

The communication unit 75 is controlled by the audio generation unit 73 to communicate with the electronic device 32 by Wi-Fi or Bluetooth (registered trademark) communication or the like and, for example, accepts a request from the electronic device 32 to emit sound for measuring a position and transmits its own position information at a timing before emitting sound.

### <Configuration Example of Electronic Device>

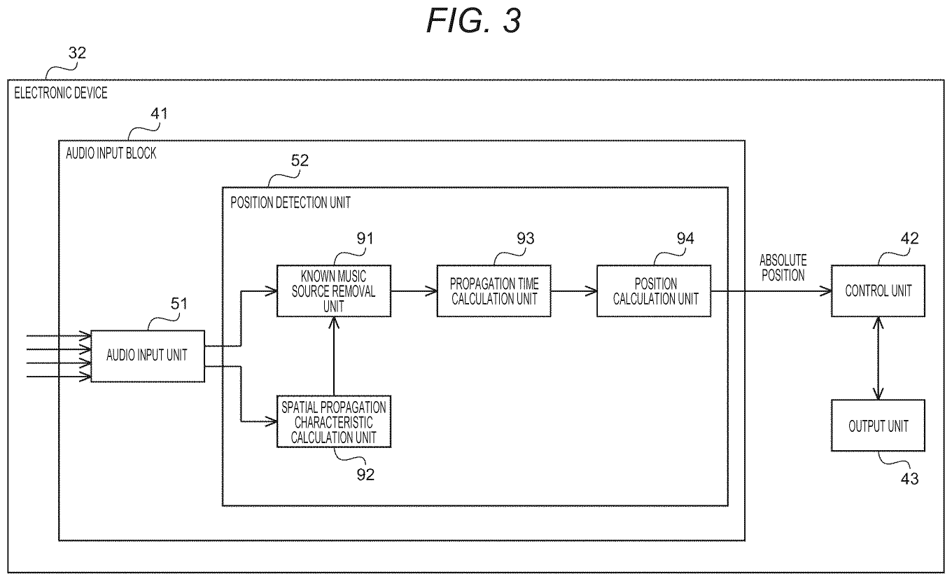

Next, a configuration example of the electronic device 32 will be described with reference to FIG. 3.

The electronic device 32 includes the audio input block 41, a control unit 42, and a communication unit 43.

The audio input block 41 accepts inputs of sound emitted from the audio output blocks 31-1 to 31-4 to find a distance to each of the audio output blocks 31-1 to 31-4 on the basis of the correlation between the spread spectrum signal and the spreading code of the accepted sound and finds its own position on the basis of the found distances to the respective audio output blocks 31-1 to 31-4 to output the found position to the control unit 42.

In a case where the electronic device 32 is a smartphone that functions as a game controller, the control unit 42 controls the communication unit 43 on the basis of the position of the electronic device 32 supplied from the audio input block 41, for example, and transmits a command for setting a sound field based on the position of the electronic device 32, to the audio output blocks 31-1 to 31-4.

In this case, the sound field control unit 83 of each of the audio output blocks 31-1 to 31-4 adjusts the sound output from the audio output unit 74 on the basis of the command for setting a sound field transmitted by the electronic device 32 and realizes an optimal sound field for the user holding the electronic device 32.

The audio input unit 51 is, for example, a microphone (mic) and collects sound emitted from the audio output blocks 31-1 to 31-4 to output the collected sound to the position detection unit 52.

The position detection unit 52 detects its own position on the basis of sound emitted from the audio output blocks 31-1 to 31-4 and outputs the detected position to the control unit 42.

In more detail, the position detection unit 52 includes a known music source removal unit 91, a spatial propagation characteristic calculation unit 92, a propagation time calculation unit 93, and a position calculation unit 94.

The spatial propagation characteristic calculation unit 92 calculates the spatial propagation characteristics on the basis of information on the sound supplied from the audio input unit 51, the characteristics of the microphone constituting the audio input unit 51, and the characteristics of the speaker constituting the audio output unit 74 of the audio output block 31, and outputs the calculated spatial propagation characteristics to the known music source removal unit 91.

The known music source removal unit 91 stores a music source stored in advance in the known music source generation unit 72 in the audio output block 31, as a known music source.

Then, the known music source removal unit 91 removes a component of the known music source from the sound supplied from the audio input unit 51 in consideration of the spatial propagation characteristics supplied from the spatial propagation characteristic calculation unit 92 and outputs the resulting sound to the propagation time calculation unit 93.

That is, the known music source removal unit 91 removes a component of the known music source from the sound collected by the audio input unit 51 and outputs only the spread spectrum signal component to the propagation time calculation unit 93.

The propagation time calculation unit 93 calculates the propagation time from when sound is emitted from each of the audio output blocks 31-1 to 31-4 to when the sound is collected, on the basis of the spread spectrum signal component included in the sound collected by the audio input unit 51, and outputs the calculated propagation time to the position calculation unit 94.

Note that the method for calculating the propagation time will be described later in detail.

The position calculation unit 94 calculates a position of the electronic device 32 on the basis of the propagation time of each of the audio output blocks 31-1 to 31-4 supplied from the propagation time calculation unit 93 and outputs the calculated position to the control unit 42.

When starting a position measurement process for its own position, the control unit 42 communicates with the audio output blocks 31, acquires position information on each audio output block 31, and outputs the acquired position information to the position calculation unit 94.

### <Principle of Communication Using Spreading Code>

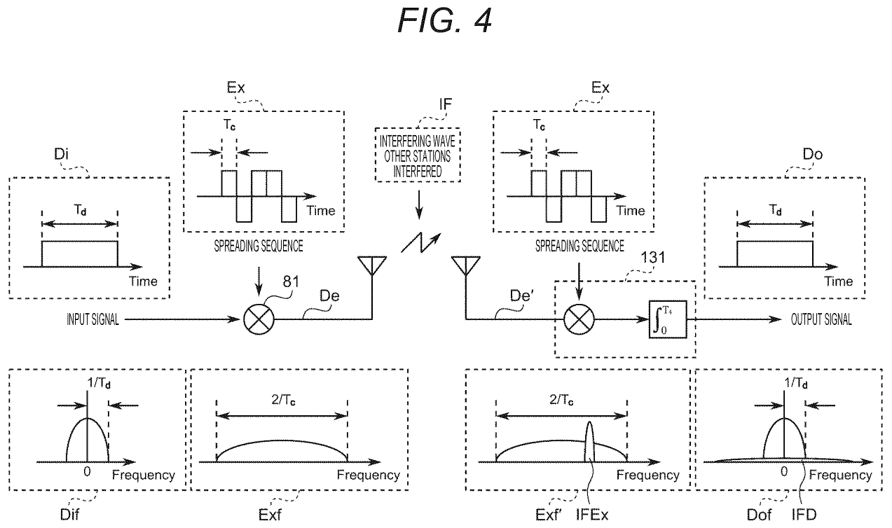

Next, the principle of communication using spreading codes will be described with reference to FIG. 4.

At the transmitting side in the left part of FIG. 4, the spreading unit 81 performs spread spectrum modulation by multiplying an input signal Di having a pulse width Td to be transmitted, by a spreading code Ex, thereby generating a transmission signal De having a pulse width Tc to transmit the generated transmission signal De to the receiving side in the right part of FIG. 4.

At this time, in a case where a frequency band Dif of the input signal Di is as indicated by, for example, a frequency band −1/Td to 1/Td, a frequency band Exf of the transmission signal De is widened by being multiplied by the spreading code Ex and converted into a frequency band −1/Tc to 1/Tc (1/Tc>1/Td), whereby energy is spread on a frequency axis.

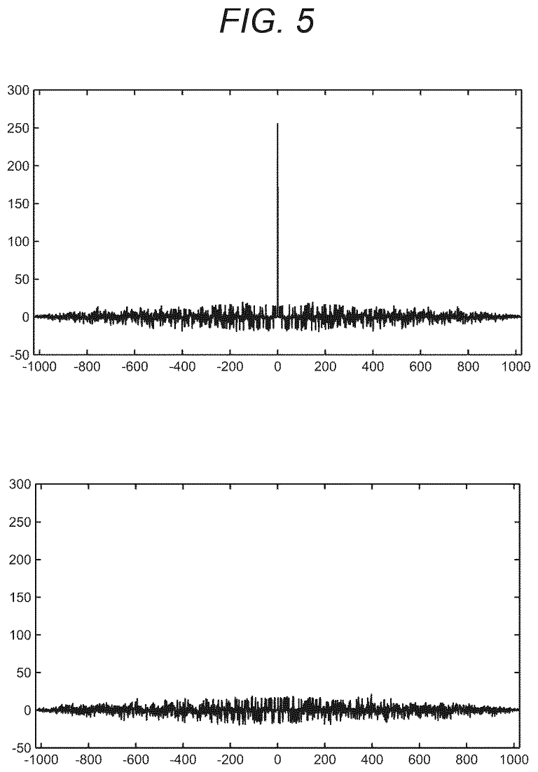

Note that FIG. 5 illustrates an example in which the transmission signal De is interfered by an interfering wave IF.

At the receiving side, a signal obtained from the transmission signal De having been interfered by the interfering wave IF is received as a reception signal De′.

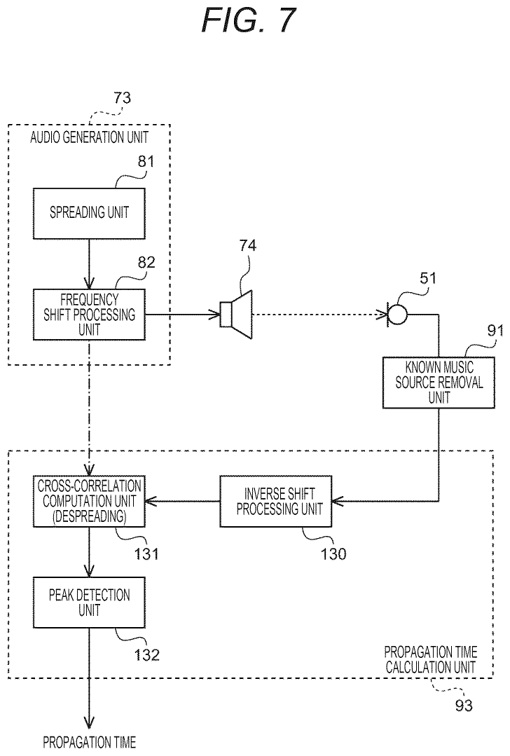

The propagation time calculation unit 93 (a cross-correlation computation unit 131 (FIG. 7) thereof) restores a reception signal Do by applying despreading to the reception signal De′ with the same spreading code Ex.

At this time, a frequency band Exf′ of the reception signal De′ includes a component IFEx of the interfering wave, but in a frequency band Dof of the despread reception signal Do, energy is spread by restoring the frequency band Dof as a frequency band IFD in which the component IFEx of the interfering wave is spread, and thus, the influence of the interfering wave IF on the reception signal Do can be reduced.

That is, as described above, in communication using the spreading code, it is possible to reduce the influence of the interfering wave IF produced on a transfer path of the transmission signal De, and it is possible to improve noise resistance.

In addition, in the spreading code, for example, autocorrelation is in the form of an impulse as illustrated in the waveform diagram in the upper part of FIG. 5, and cross-correlation has zero as illustrated by the waveform in the lower part of FIG. 5. Note that FIG. 5 illustrates a change in a correlation value in a case where a Gold sequence is used as the spreading code, where the horizontal axis denotes the coding sequence and the vertical axis denotes the correlation value.

That is, by setting a spreading code with high randomness to each of the audio output blocks 31-1 to and 31-4, in the audio input block 41, spectrum signals included in the sound can be appropriately distinguished and recognized for each of the audio output blocks 31-1 to 31-4.

The spreading code may be not only the Gold sequence but also the M sequence, pseudorandom noise (PN), or the like.

### <Method for Calculating Propagation Time by Propagation Time Calculation Unit>

The timing at which the peak of the observed cross-correlation is observed in the audio input block 41 is the timing at which the sound emitted by the audio output block 31 is collected in the audio input block 41 and thus, differs depending on the distance between the audio input block 41 and the audio output block 31.

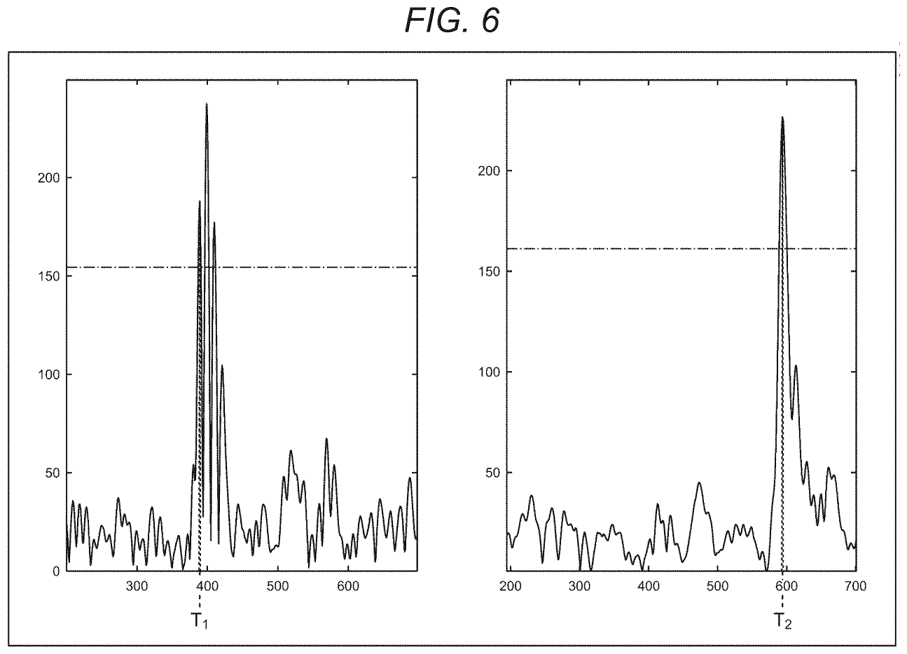

That is, for example, when the distance between the audio input block 41 and the audio output block 31 is a first distance and a peak is detected at a time T1 as illustrated in the left part of FIG. 6, the peak is observed at a time T2 (>T1) as illustrated in the right part of FIG. 6 when the distance between the audio input block 41 and the audio output block 31 is a second distance farther than the first distance.

Note that, in FIG. 6, the horizontal axis indicates the elapsed time from when sound is output from the audio output block 31, and the vertical axis indicates the strength of cross-correlation.

That is, the distance between the audio input block 41 and the audio output block 31 can be found by multiplying, by the sound velocity, the time from when sound is emitted from the audio output block 31 to when a peak is observed in the cross-correlation, that is, the propagation time until sound emitted from the audio output block 31 is collected in the audio input block 41.

### <Configuration Example of Propagation Time Calculation Unit>

Next, a configuration example of the propagation time calculation unit 93 will be described with reference to FIG. 7.

The propagation time calculation unit 93 includes an inverse shift processing unit 130, the cross-correlation computation unit 131, and a peak detection unit 132.

The inverse shift processing unit 130 restores, to the original frequency band by downsampling, a spreading code signal subjected to the spread spectrum modulation and frequency-shifted by upsampling in the frequency shift processing unit 82 of the audio output block 31, in an audio signal collected by the audio input unit 51, and outputs the restored signal to the cross-correlation computation unit 131.

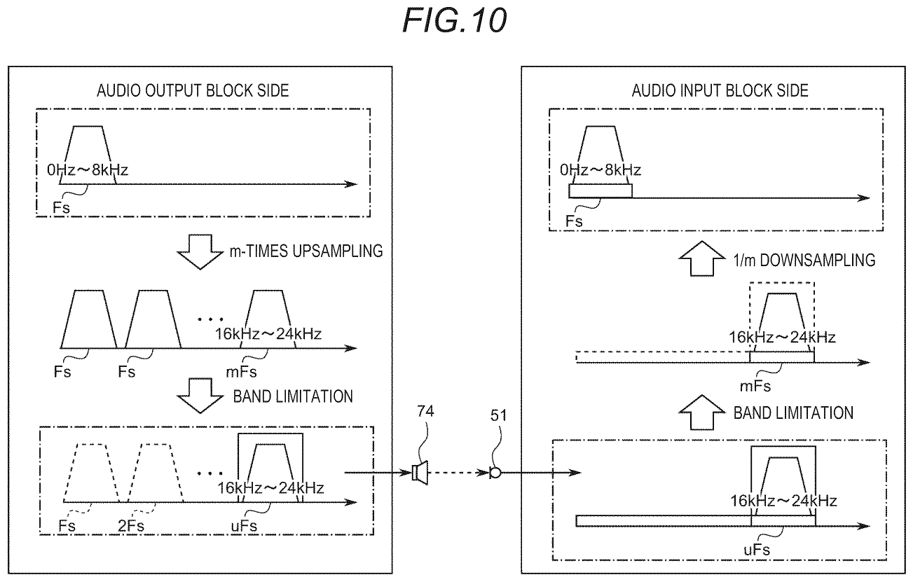

Note that shifting of the frequency band by the frequency shift processing unit 82 and restoring of the frequency band by the inverse shift processing unit 130 will be described later in detail with reference to FIG. 10.

The cross-correlation computation unit 131 computes cross-correlation between the spreading code and the reception signal from which the known music source in the audio signal collected by the audio input unit 51 of the audio input block 41 has been removed, and outputs the computed cross-correlation to the peak detection unit 132.

The peak detection unit 132 detects a time at which the cross-correlation computed by the cross-correlation computation unit 131 has a peak and outputs the detected time as a propagation time.

Here, since it is generally known that the computation of the cross-correlation performed in the cross-correlation computation unit 131 has a very large amount of computation, the calculation is achieved by equivalent computation with a small amount of computation.

Specifically, the cross-correlation computation unit 131 performs Fourier transform on each of the transmission signal output as sound by the audio output unit 74 of the audio output block 31 and the reception signal from which the known music source in the audio signal received by the audio input unit 51 of the audio input block 41 has been removed, as indicated by following Formulae (1) and (2).

$$\begin{matrix}[ Mathematical Formula 1 ] & \\ G ( f ) = {\int }_{- ∞}^{∞} g ( \frac{V - v}{V} t ) exp ( - i 2 π f t ) dt & ( 1 )\end{matrix}$$

$$\begin{matrix}[ Mathematical Formula 2 ] & \\ G ( f ) = {\int }_{- ∞}^{∞} h ( t ) exp ( - i 2 π f t ) dt & ( 2 )\end{matrix}$$

Here, g denotes the reception signal from which the known music source in the audio signal received by the audio input unit 51 of the audio input block 41 has been removed, and G denotes a result of Fourier transform of the reception signal g from which the known music source in the audio signal received by the audio input unit 51 of the audio input block 41 has been removed.

In addition, h denotes the transmission signal output as sound by the audio output unit 74 of the audio output block 31, and H denotes a result of Fourier transform of the transmission signal output as sound by the audio output unit 74 of the audio output block 31.

Furthermore, V denotes the sound velocity, v denotes the velocity of the electronic device 32 (the audio input unit 51 thereof), t denotes the time, and f denotes the frequency.

Next, the cross-correlation computation unit 131 finds a cross spectrum by multiplying the results G and H of the Fourier transform by each other as indicated by following Formula (3).

$$\begin{matrix}[ Mathematical Formula 3 ] & \\ P ( f ) = G ( f ) H ( f ) & ( 3 )\end{matrix}$$

Here, P denotes the cross spectrum found by multiplying the results G and H of the Fourier transform by each other.

Then, as indicated by following Formula (4), the cross-correlation computation unit 131 conducts inverse Fourier transform on the cross spectrum P to find cross-correlation between the transmission signal h output as sound by the audio output unit 74 of the audio output block 31 and the reception signal g from which the known music source in the audio signal received by the audio input unit 51 of the audio input block 41 has been removed.

$$\begin{matrix}[ Mathematical Formula 4 ] & \\ p ( t ) = {\int }_{- ∞}^{∞} p ( t ) exp ( - i 2 π f t ) d f & ( 4 )\end{matrix}$$

Here, p denotes cross-correlation between the transmission signal h output as sound by the audio output unit 74 of the audio output block 31 and the reception signal g from which the known music source in the audio signal received by the audio input unit 51 of the audio input block 41 has been removed.

Then, the distance between the audio input block 41 and the audio output block 31 is found by arithmetic operations of following Formula (5) on the basis of a propagation time T found on the basis of the peak of the cross-correlation p.

$$\begin{matrix}[ Mathematical Formula 5 ] & \\ D = T \times V & ( 5 )\end{matrix}$$

Here, D denotes the distance between the audio input block 41 (the audio input unit 51 thereof) and the audio output block 31 (the audio output unit 74 thereof), T denotes the propagation time, and V denotes the sound velocity. In addition, the sound velocity V is, for example, 331.5+0.6×Q (m/s) (Q denotes temperature ° C.).

Note that the cross-correlation computation unit 131 may further find the velocity v of the electronic device 32 (the audio input unit 51 thereof) by finding the cross-correlation p.

In more detail, the cross-correlation computation unit 131 finds the cross-correlation p while changing the velocity v in a predetermined range (for example, −1.00 m/s to 1.00 m/s) in a predetermined step (for example, 0.01 m/s step) and finds the velocity v indicating the maximum peak of the cross-correlation p, as the velocity v of the electronic device 32 (the audio input unit 51 thereof).

It is also possible to find the absolute velocity of the electronic device 32 (the audio input block 41 thereof) on the basis of the velocity v found for each of the audio output blocks 31-1 to 31-4.

### <Frequency Shift>

The frequency band of the spreading code signal is a frequency that is a Nyquist frequency Fs that is a half of the sampling frequency. For example, in a case where the Nyquist frequency Fs is 8 kHz, the frequency band has 0 kHz to 8 kHz that is a frequency band lower than the Nyquist frequency Fs.

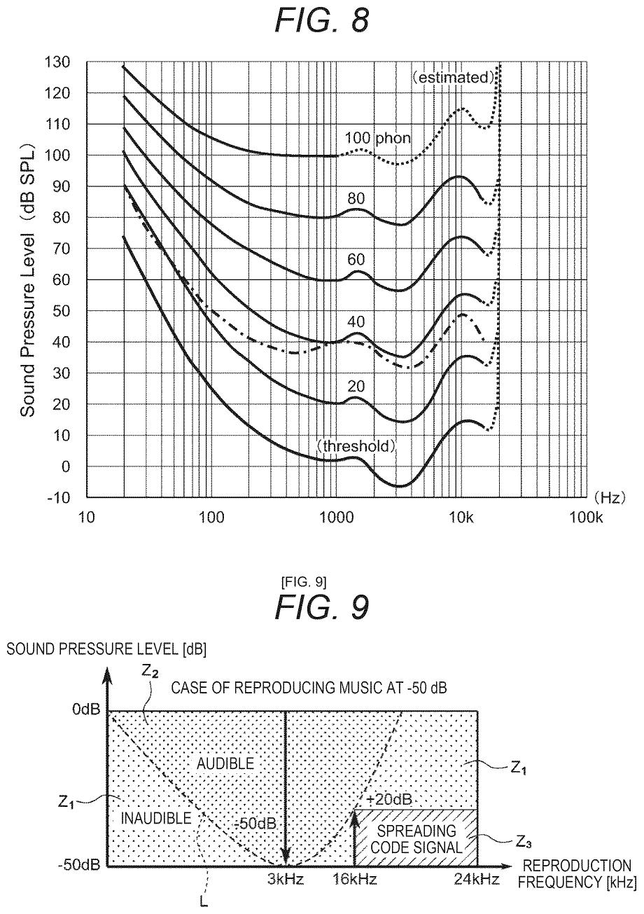

Incidentally, as illustrated in FIG. 8, it is known that human hearing has high sensitivity to sound in a frequency band around 3 kHz regardless of the level of loudness, decreases from around 10 kHz, and can hardly hear when exceeding 20 kHz.

FIG. 8 illustrates a change in the sound pressure level for each frequency at each of loudness levels 0, 20, 40, 60, 80, and 100 phons, where the horizontal axis denotes the frequency and the vertical axis denotes the sound pressure level. Note that the thick alternate long and short dash line indicates the sound pressure level of the microphone and indicates that the sound pressure level is constant irrespective of the loudness level.

Therefore, in a case where the frequency band of the spread spectrum signal is 0 kHz to 8 kHz, there is a risk that the sound of the spreading code signal is perceived as noise by human hearing when the sound of the spreading code signal is emitted together with the sound of the known music source.

For example, in a case where it is assumed that music is reproduced at −50 dB, a range below a sensitivity curve L in FIG. 9 is regarded as a range Z1 inaudible to humans (a range difficult to recognize by human hearing), and a range above the sensitivity curve L is regarded as a range Z2 audible to humans (a range easy to recognize by human hearing).

Note that, in FIG. 9, the horizontal axis indicates the frequency band, and the vertical axis indicates the sound pressure level.

Therefore, for example, when the range in which the sound of the reproduced known music source and the sound of the spreading code signal can be separated from each other is within −30 dB, the sound of the spreading code signal output in the range of 16 kHz to 24 kHz indicated by a range Z3 within the range Z1 can be made inaudible to humans (made difficult to recognize by human hearing).

Hence, as illustrated in the upper left part of FIG. 10, the frequency shift processing unit 82 upsamples a spreading code signal Fs including the spreading code m times as illustrated in the middle left part to generate spreading code signals Fs, 2Fs, . . . , and mFs.

Then, as illustrated in the lower left part of FIG. 10, the frequency shift processing unit 82 applies band limitation to a spreading code signal uFs of 16 kHz to 24 kHz that is the frequency band inaudible to humans described with reference to FIG. 9, thereby frequency-shifting the spreading code signal Fs including the spreading code signal and causing the audio output unit 74 to emit the shifted spreading code signal Fs together with the known music source.

As illustrated in the lower right part of FIG. 10, the inverse shift processing unit 130 extracts the spreading code signal uFs from the sound collected by the audio input unit 51, as illustrated in the middle right part of FIG. 10, by limiting the band to the range of 16 kHz to 24 kHz with respect to the sound from which the known music source has been removed by the known music source removal unit 91.

Then, as illustrated in the upper right part of FIG. 10, the inverse shift processing unit 130 performs downsampling to 1/m to generate the spreading code signal Fs including the spreading code, thereby restoring the frequency band to the original band.

By performing the frequency shift in this manner, even if the sound including the spreading code signal is emitted in a state where the sound of the known music source is emitted, it is possible to bring the sound including the spreading code signal into a less audible state (a less recognizable state by human hearing).

### <Method for Finding Position of Electronic Device>

Next, how to find the position of the electronic device 32 (the audio input unit 51 thereof) on the basis of a distance Dik between the electronic device 32 (the audio input unit 51 thereof) and the audio output block 31-k will be described.

Note that it is supposed that the position of the audio output block 31 (the audio output unit 74 thereof) is known by the electronic device 32 through communication with the audio output block 31 (the audio output unit 74 thereof).

In general, in a case where time synchronization is maintained between a receiving-side device (corresponding to the electronic device 32 (the audio input unit 51 thereof)) and a plurality of transmitting-side devices (corresponding to the audio output blocks 31-k), it is known that the position of the receiving-side device can be measured by a positioning approach called time of arrival (TOA) positioning.

The time of arrival (TOA) positioning is an approach of finding a position of the receiving-side device from a relationship of distances (pseudo distances) between the plurality of transmitting-side devices (positions are known) and the receiving-side device (position is unknown).

In addition, it is known that, even in a state where time synchronization is not maintained between the receiving-side device (the electronic device 32 (the audio input unit 51 thereof)) and the plurality of transmitting-side devices (the audio output blocks 31-k), the position of the electronic device 32 (the audio input unit 51 thereof) can be measured by time difference of arrival (TDOA) positioning in a case where time synchronization is maintained between the plurality of transmitting-side devices (the audio output blocks 31-k).

The time difference of arrival (TDOA) positioning is an approach of finding a position of a receiving-side device from a relationship of pseudo distance differences between the plurality of transmitting-side devices (positions are known) and the receiving-side device (position is unknown).

However, in the present disclosure, it is premised that synchronization between the audio output blocks 31-k is not maintained with each other in clocks or the like that manage time and the audio output blocks 31-k emit sound including the spreading code signal at timings that are not synchronized.

For this reason, the electronic device 32 is not allowed to measure its own position by the time of arrival (TOA) positioning or the time difference of arrival (TDOA) positioning described above.

Hence, in the present disclosure, the position is measured by an approach different from the time of arrival (TOA) positioning or the time difference of arrival (TDOA) positioning.

In the present disclosure, a constraint condition is added that the electronic device 32 is a moving body and always moves at a predetermined velocity.

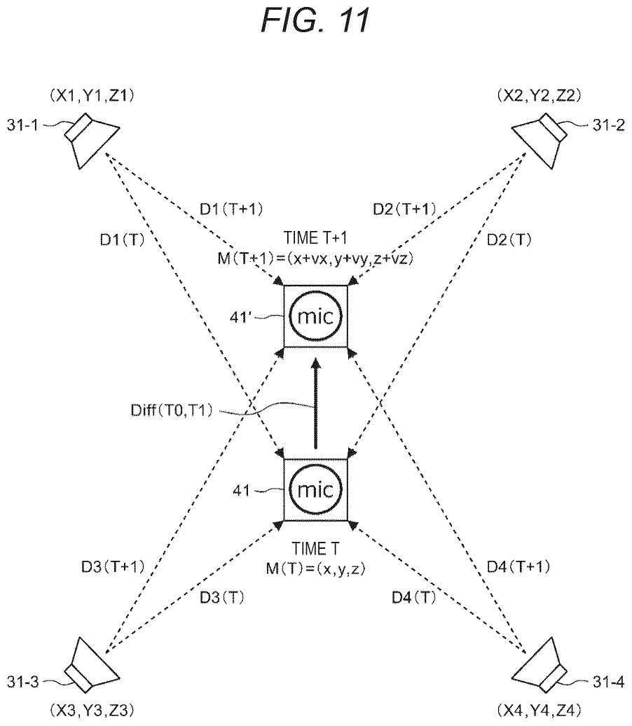

Here, as illustrated in FIG. 11, in a case where the electronic device 32 (the audio input unit 51 thereof) moves at a predetermined velocity (vx, vy, vz), the positions of the electronic device 32 (the audio input unit 51 of the audio input block 41 therein) at times T and T+1 can be expressed as M(T)=(x, y, z) and M(T+1)=(x+vx, y+vy, z+vz), respectively. At this time, if position coordinates of the audio output block 31-k are supposed as (Xk, Yk, Zk), a pseudo distance difference Diff(T, T+1) that is a difference between the pseudo distances Dk(T) and Dk(T+1) between the electronic device 32 and the audio output block 31-k at times T and T+1, respectively, is expressed as indicated by following Formula (6). Note that the interval between the times T and T+1 is, for example, a time interval equal to the length of one frame and can be deemed as a unit time.

$$D i ff ( T , T + 1 ) = ‖ ( Xk - ( x + vx ) ) + ( Yk - ( y + vy ) ) + ( Zk - ( z + vz ) ) ‖ - ‖ ( Xk - x ) + ( Yk - y ) + ( Zk - z ) ‖ \qquad ( 6 )$$

Here, ∥(Xk−x)+(Yk−y)+(Zk−z)∥ denotes a norm (pseudo distance) between the audio output block 31-k and the electronic device 32 when the position coordinates of the audio output block 31-k is supposed as (Xk, Yk, Zk) and the position coordinates of the electronic device 32 (the audio input unit 51 thereof) at the time T is supposed as (x, y, z).

In addition, ∥(Xk−(x+vx))+(Yk−(y+vy))+(Zk−(z+vz))∥ denotes a norm (pseudo distance) between the audio output block 31-k and the electronic device 32 when the position coordinates of the audio output block 31-k is supposed as (Xk, Yk, Zk) and the position coordinates of the electronic device 32 (the audio input unit 51 thereof) at the time T1 is supposed as (x+vx, y+vy, z+vz).

Therefore, in a case where the six variables of the position coordinates (x, y, z) and the moving velocity (vx, vy, vz) of the electronic device 32 (the audio input unit 51 thereof) at the time T are unknown quantities on the basis of Formula (6), it is necessary to construct simultaneous equations made up of six formulas. Accordingly, by providing six or more audio output blocks 31 and forming simultaneous equations including six or more formulas, Formula (6) can be analytically solved.

In addition, above Formula (6) can also be expressed as following Formula (7).

$$D iff ( T , T + 1 ) = Dk ( T + 1 ) - D k ( T ) = √ ( {( X k - x )}^{2} + {( Y k - y )}^{2} + {( Z k - z )}^{2} ) - √ ( {( X k - ( x + v x ) )}^{2} + {( Y k - ( y + v y ) )}^{2} + {( Z 1 - ( z + v z ) )}^{2} ) \qquad ( 7 )$$

Here, as illustrated in FIG. 11, Dk(T) denotes a distance (pseudo distance) between the position (Xk, Yk, Zk) of the audio output block 31-k and the position M(T)=(x, y, z) of the electronic device 32 (the audio input block 41 in the audio input unit 51 thereof) at the time T.

In addition, as illustrated in FIG. 11, Dk(T+1) denotes a distance (pseudo distance) between the position (Xk, Yk, Zk) of the audio output block 31-k and the position M(T+1)=(x+vx, y+vy, z+vz) of the electronic device 32 (the audio input unit 51 thereof) at the time T+1.

The pseudo distance difference that is the difference between these pseudo distance D1(T) and pseudo distance D1(T+1) can be expressed as a pseudo distance difference Diff(T, T+1) between the electronic device 32 (the audio input unit 51 thereof) and the audio output block 31-k at each of the times T and T+1.

Similarly to Formula (6), Formula (7) also has six unknown quantities of the position coordinates (x, y, z) and the moving velocity (vx, vy, vz) of the electronic device 32 (the audio input unit 51 thereof) at the time T. Accordingly, the six unknown quantities can be found by generating Formula (7) described above for six or more audio output blocks 31-k and analytically solving generated Formula (7) as simultaneous equations.

Note that, in the method for measuring a position in the present disclosure, the position is measured by constructing simultaneous equations from a pseudo distance difference (pseudo distance displacement) between each audio output block 31 and the electronic device 32 per unit time when the electronic device 32 moves at a predetermined moving velocity, as indicated by Formulae (6) and (7).

That is, since the position is measured on the basis of simultaneous equations with reference to the pseudo distance difference from the audio output block 31 per unit time identified only by time information on the electronic device 32, time synchronization with the audio output block 31 or time synchronization between the audio output blocks 31 is no longer involved.

Examples of an arithmetic approach for analytically solving the simultaneous equations constituted by Formula (7) include scipy.leastsq.

### <Position Measurement Process>

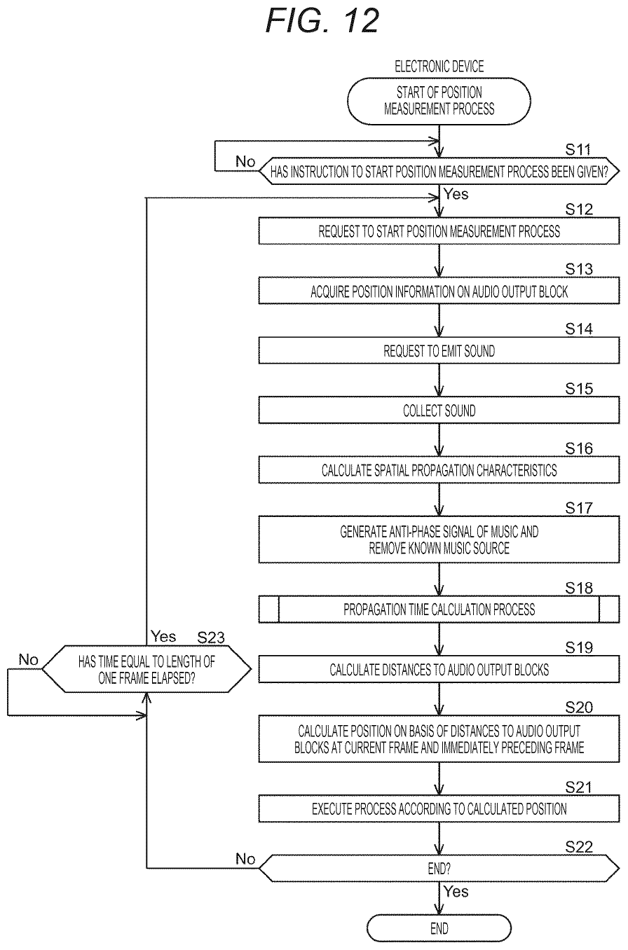

Next, a position measurement process by the audio output block 31 and the electronic device 32 will be described with reference to the flowcharts in FIGS. 12 to 14.

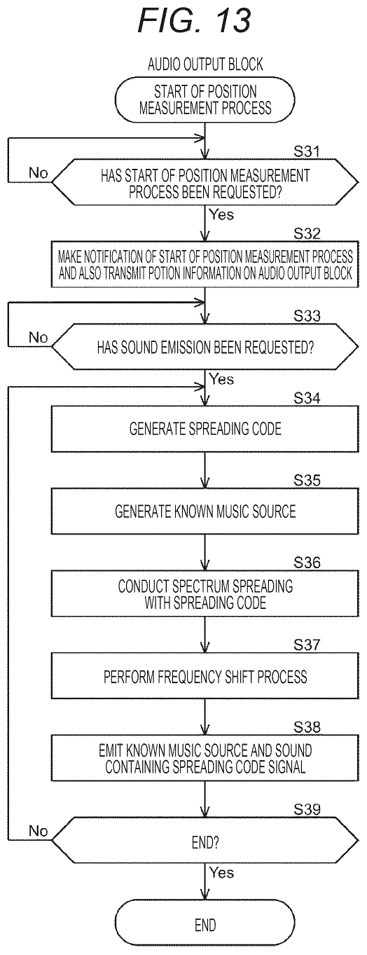

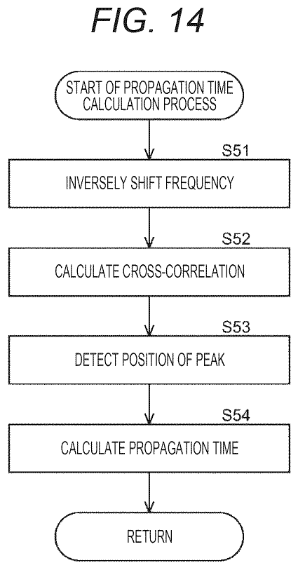

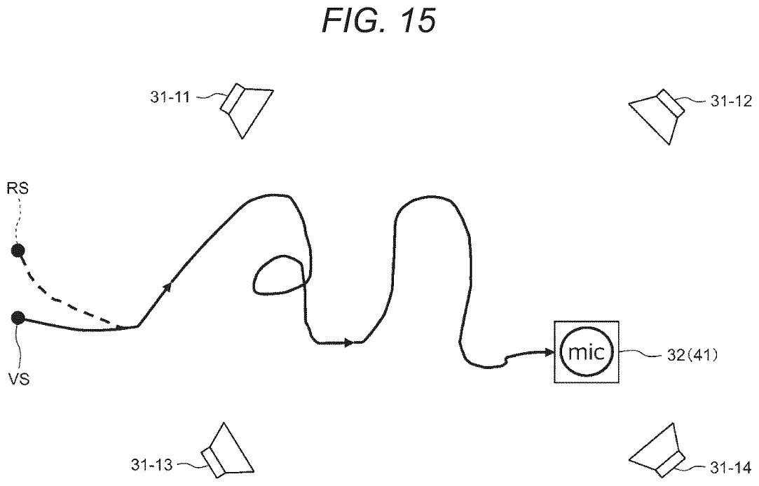

Note that FIG. 12 is a flowchart explaining a process of the electronic device 32, and FIG. 13 is a flowchart explaining a process of the audio output block 31. In addition, FIG. 14 is a flowchart explaining a propagation time calculation process in step S18 in FIG. 12.

In step S11 (FIG. 12), the control unit 42 of the electronic device 32 determines whether or not an instruction to start the position measurement process has been given by the user operating an operation unit or the like (not illustrated) and repeats a similar process until the instruction is given.

Then, in step S11, in a case where an instruction to start the position measurement process has been given, the process proceeds to step S12.

In step S12, the control unit 42 controls the communication unit 43 to request the audio output block 31 to start the position measurement process.

In step S31 (FIG. 13), the audio generation unit 73 of the audio output block 31 controls the communication unit 75 to determine whether or not the electronic device 32 has requested the start of the position measurement process and repeats a similar process until the request is received.

Then, in step S31, in a case where the electronic device 32 has requested the start of the position measurement process, the process proceeds to step S32.

In step S32, the audio generation unit 73 controls the communication unit 75 to transmit its own position information to the electronic device 32 together with information declaring the start of the position measurement process.

In step S13 (FIG. 12), the control unit 42 of the electronic device 32 controls the communication unit 43 to acquire the information declaring the start of the position measurement process and the position information supplied from the audio output block 31 and supplies the acquired information to the position calculation unit 94.

In step S14, the control unit 42 controls the communication unit 43 to request the audio output block 31 to emit sound.

In step S33 (FIG. 13), the audio generation unit 73 of the audio output block 31 controls the communication unit 75 to determine whether or not sound emission has been requested and repeats a similar process until sound emission is requested.

Then, in step S33, when sound emission has been requested, the process proceeds to step S34.

In step S34, the audio generation unit 73 controls the spreading code generation unit 71 to generate a spreading code and acquires the generated spreading code.

In step S35, the audio generation unit 73 controls the known music source generation unit 72 to generate a stored known music source and acquires the generated known music source.

In step S36, the audio generation unit 73 controls the spreading unit 81 to conduct spread spectrum modulation on a predetermined data code by multiplying the predetermined data code by the spreading code to generate a spreading code signal.

In step S37, the audio generation unit 73 controls the frequency shift processing unit 82 to frequency-shift the spreading code signal according to the respective frequency characteristics of the audio output unit 74 as described with reference to the left part of FIG. 10.

In step S38, the audio generation unit 73 outputs the known music source and the frequency-shifted spreading code signal to each audio output unit 74 constituted by a speaker and causes each audio output unit 74 to emit (output) the known music source and the spreading code signal as sound.

By performing the above process in each of the audio output blocks 31-1 to 31-4, it is possible to emit sound to the user holding the electronic device 32 and allow the user to perceive the sound as the known music source.

In addition, since the spreading code signal can be shifted to a frequency band inaudible to a human who is the user and output as sound, the electronic device 32 can measure the distance to the audio output block 31 on the basis of the emitted sound constituted by the spreading code signal and shifted to the frequency band inaudible to humans without causing the user to hear an unpleasant sound.

In step S15 (FIG. 12), the audio input unit 51 constituted by a microphone collects sound and outputs the collected sound to the known music source removal unit 91 and the spatial propagation characteristic calculation unit 92 of the position detection unit 52.

In step S16, the spatial propagation characteristic calculation unit 92 calculates the spatial propagation characteristics on the basis of the sound supplied from the audio input unit 51, the characteristics of the audio input unit 51, and the characteristics of the audio output unit 74 of the audio output block 31 and outputs the calculated spatial propagation characteristics to the known music source removal unit 91.

In step S17, the known music source removal unit 91 generates an anti-phase signal of the known music source in consideration of the spatial propagation characteristics supplied from the spatial propagation characteristic calculation unit 92, removes a component of the known music source from the sound supplied from the audio input unit 51, and outputs the resulting sound to the propagation time calculation unit 93.

In step S18, the propagation time calculation unit 93 executes the propagation time calculation process to calculate the propagation time until the sound output from the audio output block 31 is propagated to the audio input unit 51.

### <Propagation Time Calculation Process>

Here, the propagation time calculation process by the propagation time calculation unit 93 will be described with reference to the flowchart in FIG. 14.

In step S51, the inverse shift processing unit 130 inversely shifts the frequency band of the spreading code signal obtained by removing the known music source from the sound input by the audio input unit 51 and supplied from the known music source removal unit 91, as described with reference to the right part of FIG. 10.

In step S52, the cross-correlation computation unit 131 calculates cross-correlation between the spreading code signal obtained by inversely shifting the frequency band and removing the known music source from the sound input by the audio input unit 51, and the spreading code signal of the sound output from the audio output block 31, by the computation using Formulae (1) to (4) described above.

In step S53, the peak detection unit 132 detects a peak in the computed cross-correlation.

In step S54, the peak detection unit 132 outputs the time detected as the peak in the cross-correlation to the position calculation unit 95 as the propagation time.

Note that the propagation time relevant to each of the plurality of audio output blocks 31 is found by calculating the cross-correlation with the spreading code signal of the sound output from each of the plurality of audio output blocks 31.

Here, the description returns to the flowchart in FIG. 12.

In step S19, the position calculation unit 95 calculates distances (pseudo distances) to the plurality of audio output blocks 31.

In step S20, the position calculation unit 95 generates simultaneous equations constituted by above-described Formula (7) having its own position as unknown quantities from the distances (pseudo distances) to the plurality of audio output blocks 31 to calculate its own position by solving the simultaneous equations and outputs the calculated position to the control unit 42.

Note that, since this process is performed at the timing corresponding to the time (T+1) described with reference to FIG. 11, in the process at the first time, the position coordinates (x, y, z) of the electronic device 32 (the audio input unit 51 thereof) corresponding to the time T do not exist, and thus, predetermined position coordinates are used as initial values.

In step S21, the control unit 42 executes a process based on the position of the electronic device 32 that is its own position that has been found.

For example, the control unit 42 controls the communication unit 43 to transmit, to the audio output blocks 31-1 to 31-4, a command for controlling the level and timing of the sound output from each of the audio output units 74 of the audio output blocks 31-1 to 31-4 such that a sound field based on the found position of the electronic device 32 can be achieved.

As a result, in the audio output blocks 31-1 to 31-4, the sound field control unit 83 controls the level and timing of the sound output from the audio output unit 74 so as to achieve the sound field relevant to the position of the user holding the electronic device 32 on the basis of the command transmitted from the electronic device 32.

In step S22, the control unit 42 determines whether or not an instruction to end the process has been given, and in a case where an instruction to end has not been given, the process proceeds to step S23.

In step S23, the control unit 42 determines whether or not time equal to the length of one frame has elapsed from the immediately preceding process and repeats a similar process until it is determined that the time has elapsed. Then, in step S23, it is determined whether or not the time (unit time) equal to the length of one frame has elapsed from the immediately preceding process, and in a case where it is determined that the time has elapsed, the process returns to step S12, and the processes in step S12 and the subsequent steps are repeated.

Then, in step S22, in a case where it is determined that an instruction to end has been given, the process ends.

The above process enables measurement of the position of the electronic device 32 with high accuracy even if synchronization between the audio output blocks 31-1 to 31-k are not maintained with each other in clocks or the like that manage time and sound including the spreading code signal is emitted at asynchronous timings.

Note that, as described above, since the position coordinates of the electronic device 32 do not exist in the process at the first time, predetermined position coordinates will be used as initial values.

However, since the position information actually measured in the immediately preceding process will be used from the processes at the second and subsequent times, the position information approximates to the real position information as time elapses. That is, for example, as illustrated in FIG. 15, a case where a predetermined initial position VS is set for the process at the first time, but in reality, the electronic device 32 exists at a start position RS will be examined.

Even in such a case, since the measurement of the position is repeated using the position information actually measured by the electronic device 32 from the processes at the second and subsequent times, as illustrated in FIG. 15, the trajectory of the solid line plotting the position of the electronic device 32 indicated as arithmetic operation results approaches the real trajectory indicated by the dotted line, and finally, the result of the position measurement and the real trajectory will match.

In addition, in the above, an example has been described in which Formula (7) including unknown quantities is generated from the information on the distances from the electronic device 32 for each audio output block 31-k based on the spreading code signal and the position of the electronic device 32 is found analytically as simultaneous equations.

However, the information on the distance differences in the electronic device 32 for each audio output block 31-k based on the spreading code signal, and the known coordinate positions of the audio output blocks 31-k and the actual position information on the electronic device 32 may be paired, and the position may be measured by machine learning using a simple deep neural network (DNN) model or simple boosting such as XGBoost, for example.

In addition, at this time, the velocity of the electronic device 32 may be measured on the basis of the Doppler frequency shift produced in the collected sound along with the movement of the electronic device 32, and information on the velocity that is measurement results may be substituted into above-described (vx, vy, vz).

In this manner, in a case where the position measurement using the machine learning is introduced, by adopting the velocity of the electronic device 32 as an input value together, as well as the distances to the audio output blocks 31-k based on the cross-correlation, the accuracy of measuring the position of the electronic device 32 can be improved.

In addition, an approach by machine learning and an analytical approach may be combined. For example, the initial position may be estimated by the machine learning, and the position may be measured by the analytical approach in the processes at the second and subsequent times, using the initial position estimated by the machine learning.

Note that, in the above, an example has been described in which the audio signal utilizing sound (sound wave) is used as a transmission medium of the modulated signal that is a ranging signal. However, for example, another transmission medium such as a radio wave or light may be utilized. For example, in a smart factory or the like, a user position tracking system or the like may be implemented to identify the position of a smartphone held by a user by transmitting and receiving the ranging signal constituted by the modulated signal, using a radio wave such as an ultra wide band (UWB) as a transmission medium.

In this manner, in a case where the ranging signal constituted by the modulated signal is transmitted and received using a radio wave such as the UWB as a transmission medium, the audio output block 31 that transmits (outputs) the ranging signal constituted by the above-described audio signal to emit sound may be replaced with, for example, a radio wave output block 31 that transmits (outputs) the ranging signal constituted by a radio wave signal, which, in one configuration, may be installed at a known position in the smart factory. In addition, in this case, the audio input block 41 that collects sound and receives (accepts an input of) the ranging signal constituted by the audio signal may be replaced with a radio wave input block 41 or the like that receives (accept an input of) the ranging signal constituted by a radio wave signal, for example, which, in one configuration, may be incorporated into the smartphone held by the user.

In addition, in a case where another medium apart from the sound wave and the radio wave, such as light, is used as a transmission medium, the audio output block 31 and the audio input block 41 may be replaced with, for example, an optical output block 31 and an optical input block 41 that transmit and receive an optical signal using light as a transmission medium as the ranging signal constituted by the modulated signal.

Furthermore, the audio output block 31 and the audio input block 41 may be replaced with a ranging signal output block 31 that outputs (transmits) the ranging signal and a ranging signal input block 41 that receives (inputs) the ranging signal, respectively, regardless of the type of transmission medium of the ranging signal.

In addition, as for the modulated signal, an example has been described in which a signal to which modulation has been applied with the spreading code is transmitted and received. However, other signals may be employed, and for example, a transmission signal such as a frequency modulated continuous wave (FMCW) or a Bluetooth Low Energy (BLE) beacon may be employed.

### 2. First Modification

An example in which the position of the electronic device 32 is measured when the position of the electronic device 32 is unknown and the positions of the audio output blocks 31-k are known has been described above.

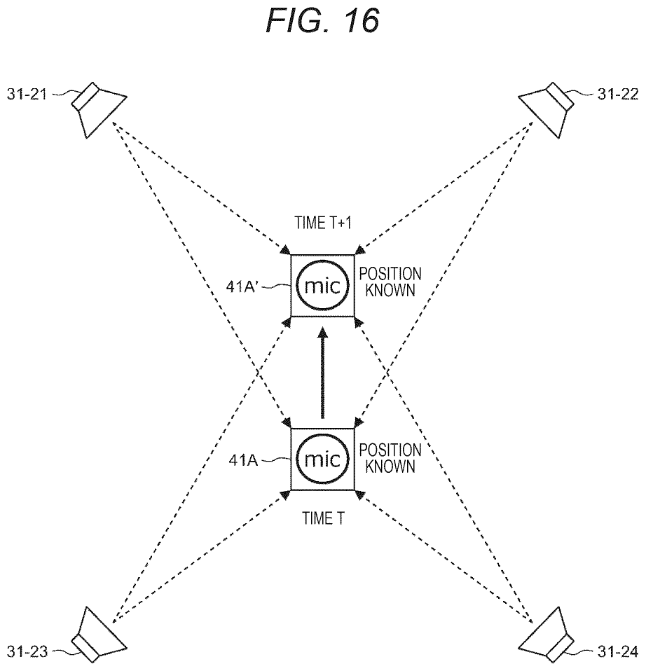

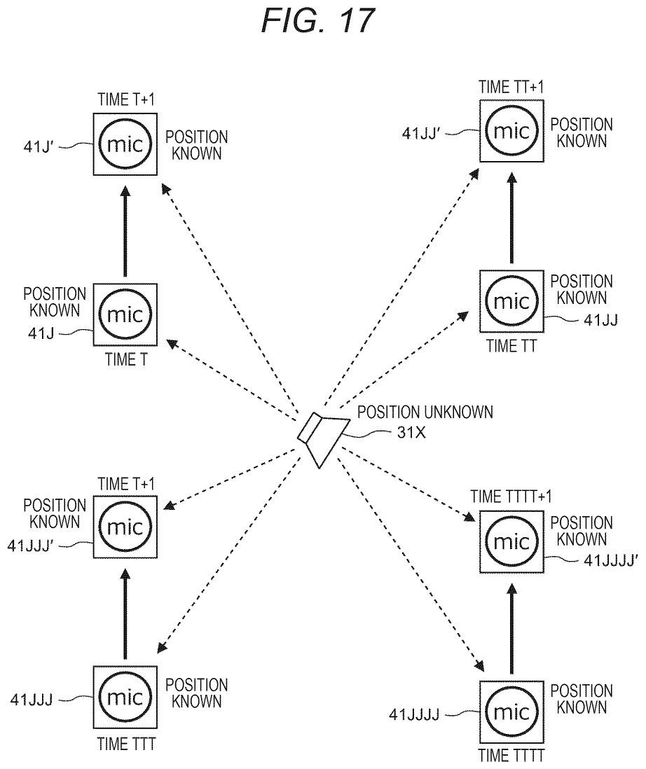

However, for example, as illustrated in FIG. 16, if the position of the electronic device 32 can be made known with an inertial measurement unit (IMU), simultaneous localization and mapping (SLAM), or the like provided in the electronic device 32, the positions of the audio output blocks 31-k can be measured by an approach similar to the above-described approach even if unknown.

That is, FIG. 16 illustrates a configuration example of an acoustic positioning system constituted by an audio input block 41A of the electronic device 32 whose self position is known by the IMU, SLAM, or the like, and audio output blocks 31-21 to 31-24 whose positions are unknown.

Even in the configuration as illustrated in FIG. 16, the processes to be performed are substantially similar to the processes described with reference to the flowcharts in FIGS. 12 to 14.

However, in this case, the unknown quantities are the position coordinates of the audio output blocks 31, and since the number of involved simultaneous equations depends on the unknown quantities, it is necessary to install a number of the audio output blocks 31 according to the number of unknown quantities or to repeatedly perform measurement a number of times according to the number of unknown quantities.

With such a configuration, when the audio output blocks 31 are installed, it is not necessary to individually measure the positions before installation, but it is only necessary to measure the positions by the above-described approach after installation and, as necessary, to adjust the positions.

In addition, after the measurement of the position of the audio output block 31 is completed, similarly to the above, the audio output block 31 can be caused to function as the audio output block 31 whose position is known and can contribute to the measurement of the position of the electronic device 32 whose position is unknown.

In addition, at this time, the moving velocity of the electronic device 32 may be found and substituted using the IMU, SLAM, or the like, and this way of proceeding can improve the accuracy of measuring the position.

### 3. Second Modification

As described above, the timings at which sound is emitted from the audio output blocks 31 do not need to be synchronized, and additionally, it is sufficient that above-described Formula (7) can be generated by an amount relevant to the number of unknown quantities.

Accordingly, for example, in a case where the unknowns quantities are six, the position of the electronic device 32 may be found by generating and solving simultaneous equations by six or more Formulae (7) obtained by measuring the spreading code signal separately six or more times while moving around one audio output block 31. Therefore, in this case, only one audio output block 31 is required.

However, for example, a case will be examined in which there is one audio output block 31 whose position is unknown, there is the audio input block 41 of the electronic device 32 whose self position can be made known by the IMU, SLAM, or the like, and there are a total of four unknown quantities including three unknown quantities of the coordinate position of the audio output block 31. However, in this example, it is supposed that the audio input block 41 can also measure a predetermined velocity when the audio input block 41 moves and the predetermined velocity is known.

As illustrated in FIG. 17, for example, in the first time, one Formula (7) is generated on the basis of the difference between pseudo distances to an audio output block 31X at each of positions 41J and 41J′ when the audio input block 41 moves to the position 41J′ from the position 41J at a predetermined velocity during a period from the time T to the time T+1 corresponding to the length of one frame.

In addition, for example, in the second time, one Formula (7) is generated on the basis of the difference between pseudo distances to the audio output block 31X when the audio input block 41 moves to a position 41JJ′ from a position 41JJ at a predetermined velocity during a period from a time TT to a time TT+1 corresponding to the length of one frame.

Furthermore, for example, in the third time, one Formula (7) is generated on the basis of the difference between pseudo distances to the audio output block 31X when the audio input block 41 moves to a position 41JJJ′ from a position 41JJJ at a predetermined velocity during a period from a time TTT to a time TTT+1 corresponding to the length of one frame.

In addition, for example, in the fourth time, one Formula (7) is generated on the basis of the difference between pseudo distances to the audio output block 31X when the audio input block 41 moves to a position 41JJJJ′ from a position 41JJJJ at a predetermined velocity during a period from a time TTTT to a time TTTT+1 corresponding to the length of one frame.

By solving the simultaneous equations of four Formulae (7) found in this manner, four unknown quantities including the position coordinates of the audio output block 31X are found.

### 4. Example of Execution by Software

Incidentally, the series of processes described above can be executed by hardware, but can also be executed by software. In a case where the series of processes is executed by software, a program constituting the software is installed from a recording medium into, for example, a computer built in dedicated hardware or a general-purpose computer capable of executing various functions by installing various programs, or the like.

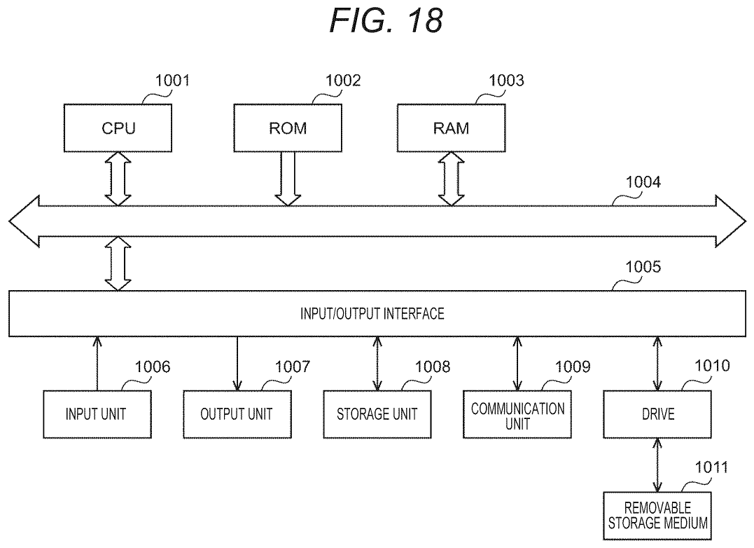

FIG. 18 illustrates a configuration example of a general-purpose computer. This computer incorporates a central processing unit (CPU) 1001. An input/output interface 1005 is connected to the CPU 1001 via a bus 1004. A read only memory (ROM) 1002 and a random access memory (RAM) 1003 are connected to the bus 1004.

To the input/output interface 1005, an input unit 1006 including an input device such as a keyboard and a mouse with which a user inputs operation commands, an output unit 1007 that outputs a processing operation screen and an image of a processing result to a display device, a storage unit 1008 that stores programs and various sorts of data and includes a hard disk drive and the like, and a communication unit 1009 including a local area network (LAN) adapter or the like and executes communication processing via a network represented by the Internet are connected. In addition, a drive 1010 that reads and writes data from and to a removable storage medium 1011 such as a magnetic disk (including a flexible disk), an optical disc (including compact disc-read only memory (CD-ROM) and digital versatile disc (DVD)), a magneto-optical disk (including mini disc (MD)), or a semiconductor memory is connected.

The CPU 1001 executes various processes in accordance with a program stored in the ROM 1002, or a program read from the removable storage medium 1011 such as a magnetic disk, an optical disc, a magneto-optical disk, or a semiconductor memory, installed into the storage unit 1008, and loaded into the RAM 1003 from the storage unit 1008. In addition, the RAM 1003 also stores data necessary for the CPU 1001 to execute various processes, and the like, as appropriate.

In the computer configured as described above, for example, the CPU 1001 loads the program stored in the storage unit 1008 into the RAM 1003 via the input/output interface 1005 and the bus 1004 and executes the program to perform the above-described series of processes.

The program executed by the computer (CPU 1001) can be provided by being recorded in the removable storage medium 1011 as a package medium or the like, for example. In addition, the program can be provided via a wired or wireless transfer medium such as a local area network, the Internet, or digital satellite broadcasting.

In the computer, the program can be installed into the storage unit 1008 via the input/output interface 1005 by attaching the removable storage medium 1011 to the drive 1010. In addition, the program can be received by the communication unit 1009 via a wired or wireless transfer medium and installed into the storage unit 1008. Besides, the program can be installed into the ROM 1002 or the storage unit 1008 in advance.

Note that the program executed by the computer may be a program that performs processing in a time-series manner in the order described in the present description, or may be a program that performs processing in parallel or at a necessary timing such as when a call is made.

Note that the CPU 1001 in FIG. 18 implements the functions of the audio output block 31 and the audio input block 41 in FIG. 1.

In addition, in the present description, a system is intended to mean assembly of a plurality of constituent elements (devices, modules (parts), and the like) and it does not matter whether or not all the constituent elements are in the same housing. Therefore, a plurality of devices accommodated in separate housings and connected via a network and one device in which a plurality of modules is accommodated in one housing are both systems.

Note that embodiments of the present disclosure are not limited to the embodiments described above, and various alterations may be made without departing from the scope of the present disclosure.

For example, the present disclosure may have a cloud computing configuration in which one function is shared by a plurality of devices via a network and processing is performed in cooperation.

In addition, each step described in the flowcharts described above may be executed by one device, or can also be executed by a plurality of devices in a shared manner.

Furthermore, in a case where a plurality of processes is included in one step, the plurality of processes included in one step can be executed by one device or by a plurality of devices in a shared manner as well.

Note that the present disclosure may also have configurations as described below.

<1> A program for causing a computer to function as:
an audio reception unit that receives an audio signal that is output from an audio output block and is constituted by a spreading code signal obtained by conducting spread spectrum modulation on a spreading code; and
a position calculation unit that calculates a position of the audio reception unit or the audio output block on the basis of a distance to the audio output block identified from a propagation time that is a time until the audio signal from the audio output block is propagated to and received by the audio reception unit, in which
the position calculation unit calculates the position of the audio reception unit or the audio output block on the basis of a distance difference from the audio output block per unit time when the position calculation unit moves at a predetermined velocity.

<2> The program according to <1>, in which
in a case where the position of the audio output block is known and the position of the audio reception unit is unknown, the position calculation unit calculates the position of the audio reception unit on the basis of the distance difference from the audio output block per unit time when the position calculation unit moves at a predetermined velocity, and the known position of the audio output block.

<3> The program according to <2>, in which
the position calculation unit calculates the position of the audio reception unit on the basis of the distance differences from a plurality of the audio output blocks per unit time when the position calculation unit moves at a predetermined velocity.

<4> The program according to <2>, in which
the position calculation unit calculates the position of the audio reception unit on the basis of the distance differences from the audio output block per unit time obtained a plurality of times when the position calculation unit moves at a predetermined velocity.

<5> The program according to <2>, in which
the position calculation unit calculates the position of the audio reception unit by an analytical approach on the basis of the distance difference from the audio output block when the position calculation unit moves at a predetermined velocity, and the known position of the audio output block.

<6> The program according to <2>, in which
the position calculation unit calculates the position of the audio reception unit by machine learning on the basis of the distance difference from the audio output block when the position calculation unit moves at a predetermined velocity, and the known position of the audio output block.

<7> The program according to <2>, in which
the position calculation unit calculates the position of the audio reception unit by machine learning on the basis of the distance difference from the audio output block when the position calculation unit moves at a predetermined velocity, and the known position of the audio output block, as well as the predetermined velocity related to the position calculation unit when moving.

<8> The program according to <7>, in which
the predetermined velocity related to the moving is identified on the basis of a Doppler frequency shift produced in the audio signal received by the audio reception unit, due to the position calculation unit moving at the predetermined velocity.

<9> The program according to <1>, further including
a propagation time calculation unit that calculates the propagation time until the audio signal from the audio output block is propagated to the audio reception unit, in which
the position calculation unit calculates the position of the audio reception unit or the audio output block on the basis of the distance difference to the audio output block per unit time identified from the propagation time of the audio signal from the audio output block when the position calculation unit moves at a predetermined velocity.

<10> The program according to <9>, in which
the propagation time calculation unit includes:
a cross-correlation computation unit that computes cross-correlation between the spreading code signal in the audio signal received by the audio reception unit and the spreading code signal in the audio signal output from the audio output block; and
a peak detection unit that detects a time at which the cross-correlation has a peak, as the propagation time, and
the position calculation unit calculates the position of the audio reception unit or the audio output block on the basis of the distance difference to the audio output block per unit time identified from the propagation time of the audio signal relevant to the peak when the position calculation unit moves at a predetermined velocity.

<11> The program according to <1>, in which
the position of the audio output block is made known by being transmitted from the audio output block.

<12> The program according to <1>, in which
in a case where the position of the audio output block is unknown and the position of the audio reception unit is known, the position calculation unit calculates the position of the audio output block on the basis of the distance difference from the audio output block per unit time when the position calculation unit moves at a predetermined velocity, and the known position of the audio reception unit.

<13> The program according to <12>, in which
the position of the audio reception unit is made known by an inertial measurement unit (IMU) or simultaneous localization and mapping (SLAM).

<14> An information processing device including:
an audio reception unit that receives an audio signal that is output from an audio output block and is constituted by a spreading code signal obtained by conducting spread spectrum modulation on a spreading code; and
a position calculation unit that calculates a position of the audio reception unit or the audio output block on the basis of a distance to the audio output block identified from a propagation time that is a time until the audio signal from the audio output block is propagated to and received by the audio reception unit, in which
the position calculation unit calculates the position of the audio reception unit or the audio output block on the basis of a distance difference from the audio output block per unit time when the position calculation unit moves at a predetermined velocity.

<15> The information processing device according to <14>, in which
the audio reception unit is provided on a smartphone or a head mounted display (HMD).

<16> An information processing method including: an audio reception unit that receives an audio signal that is output from an audio output block and is constituted by a spreading code signal obtained by conducting spread spectrum modulation on a spreading code; and
a position calculation unit that calculates a position of the audio reception unit or the audio output block on the basis of a distance to the audio output block identified from a propagation time that is a time until the audio signal from the audio output block is propagated to and received by the audio reception unit,
the information processing method including
a step of calculating, by the position calculation unit, the position of the audio reception unit or the audio output block on the basis of a distance difference from the audio output block per unit time when the position calculation unit moves at a predetermined velocity.

### REFERENCE SIGNS LIST

11 Acoustic positioning system
31, 31-1 to 31-4 Audio output block
32 Electronic device
41 Audio input block
42 Control unit
43 Output unit
44 Communication unit
51 Audio input unit
51 Position detection unit
71 Spreading code generation unit
72 Known music source generation unit
73 Audio generation unit
74 Audio output unit
81 Spreading unit
82 Frequency shift processing unit
83 Sound field control unit
91 Known music source removal unit
92 Spatial propagation characteristic calculation unit
93 Arrival time calculation unit
94 Position calculation unit
130 Inverse shift processing unit
131 Cross-correlation computation unit
132 Peak detection unit

1. A program for causing a computer to function as:
a ranging signal reception unit that receives a ranging signal that is output from a ranging signal output block and is constituted by a spreading code signal obtained by conducting spread spectrum modulation on a spreading code; and
a position calculation unit that calculates a position of the ranging signal reception unit or the ranging signal output block on a basis of a distance to the ranging signal output block identified from a propagation time that is a time until the ranging signal from the ranging signal output block is propagated to and received by the ranging signal reception unit, wherein the position calculation unit calculates the position of the ranging signal reception unit or the ranging signal output block on a basis of a distance difference from the ranging signal output block per unit time when the position calculation unit moves at a predetermined velocity.

2. The program according to claim 1, wherein
in a case where the position of the ranging signal output block is known and the position of the ranging signal reception unit is unknown, the position calculation unit calculates the position of the ranging signal reception unit on a basis of the distance difference from the ranging signal output block per unit time when the position calculation unit moves at a predetermined velocity, and the known position of the ranging signal output block.

3. The program according to claim 2, wherein
the position calculation unit calculates the position of the ranging signal reception unit on a basis of the distance differences from a plurality of the ranging signal output blocks per unit time when the position calculation unit moves at a predetermined velocity.

4. The program according to claim 2, wherein
the position calculation unit calculates the position of the ranging signal reception unit on a basis of the distance differences from the ranging signal output block per unit time obtained a plurality of times when the position calculation unit moves at a predetermined velocity.

5. The program according to claim 2, wherein
the position calculation unit calculates the position of the ranging signal reception unit by an analytical approach on a basis of the distance difference from the ranging signal output block when the position calculation unit moves at a predetermined velocity, and the known position of the ranging signal output block.

6. The program according to claim 2, wherein
the position calculation unit calculates the position of the ranging signal reception unit by machine learning on a basis of the distance difference from the ranging signal output block when the position calculation unit moves at a predetermined velocity, and the known position of the ranging signal output block.

7. The program according to claim 2, wherein
the position calculation unit calculates the position of the ranging signal reception unit by machine learning on a basis of the distance difference from the ranging signal output block when the position calculation unit moves at a predetermined velocity, and the known position of the ranging signal output block, as well as the predetermined velocity related to the position calculation unit when moving.

8. The program according to claim 7, wherein
the predetermined velocity related to the moving is identified on a basis of a Doppler frequency shift produced in the ranging signal received by the ranging signal reception unit, due to the position calculation unit moving at the predetermined velocity.

9. The program according to claim 1, further comprising
a propagation time calculation unit that calculates the propagation time until the ranging signal from the ranging signal output block is propagated to the ranging signal reception unit, wherein
the position calculation unit calculates the position of the ranging signal reception unit or the ranging signal output block on a basis of the distance difference to the ranging signal output block per unit time identified from the propagation time of the ranging signal from the ranging signal output block when the position calculation unit moves at a predetermined velocity.

10. The program according to claim 9, wherein
the propagation time calculation unit includes:
a cross-correlation computation unit that computes cross-correlation between the spreading code signal in the ranging signal received by the ranging signal reception unit and the spreading code signal in the ranging signal output from the ranging signal output block; and
a peak detection unit that detects a time at which the cross-correlation has a peak, as the propagation time, and
the position calculation unit calculates the position of the ranging signal reception unit or the ranging signal output block on a basis of the distance difference to the ranging signal output block per unit time identified from the propagation time of the ranging signal relevant to the peak when the position calculation unit moves at a predetermined velocity.

11. The program according to claim 1, wherein
the position of the ranging signal output block is made known by being transmitted from the ranging signal output block.

12. The program according to claim 1, wherein
in a case where the position of the ranging signal output block is unknown and the position of the ranging signal reception unit is known, the position calculation unit calculates the position of the ranging signal output block on a basis of the distance difference from the ranging signal output block per unit time when the position calculation unit moves at a predetermined velocity, and the known position of the ranging signal reception unit.

13. The program according to claim 12, wherein
the position of the ranging signal reception unit is made known by an inertial measurement unit (IMU) or simultaneous localization and mapping (SLAM).

14. The program according to claim 1, wherein
the ranging signal includes an audio signal, a radio wave signal, and an optical signal.

15. An information processing device comprising:
a ranging signal reception unit that receives a ranging signal that is output from a ranging signal output block and is constituted by a spreading code signal obtained by conducting spread spectrum modulation on a spreading code; and
a position calculation unit that calculates a position of the ranging signal reception unit or the ranging signal output block on a basis of a distance to the ranging signal output block identified from a propagation time that is a time until the ranging signal from the ranging signal output block is propagated to and received by the ranging signal reception unit, wherein
the position calculation unit calculates the position of the ranging signal reception unit or the ranging signal output block on a basis of a distance difference from the ranging signal output block per unit time when the position calculation unit moves at a predetermined velocity.

16. The information processing device according to claim 15, wherein
the ranging signal reception unit is provided on a smartphone or a head mounted display (HMD).

17. An information processing method including: a ranging signal reception unit that receives a ranging signal that is output from a ranging signal output block and is constituted by a spreading code signal obtained by conducting spread spectrum modulation on a spreading code; and
a position calculation unit that calculates a position of the ranging signal reception unit or the ranging signal output block on a basis of a distance to the ranging signal output block identified from a propagation time that is a time until the ranging signal from the ranging signal output block is propagated to and received by the ranging signal reception unit,
the information processing method comprising
a step of calculating, by the position calculation unit, the position of the ranging signal reception unit or the ranging signal output block on a basis of a distance difference from the ranging signal output block per unit time when the position calculation unit moves at a predetermined velocity.
